(19) United States
(12) Patent Application Publication
(10) Pub. No.: US 2019/0241297 A1
(43) Pub. Date: Aug. 8, 2019

(54) Method and Apparatus for Sealing Film Bags

(71) Applicant: Frito-Lay North America, Inc., Plano, TX (US)

(72) Inventor: Frank Mathew BRENKUS, McKinney, TX (US)

(21) Appl. No.: 15/891,462

(22) Filed: Feb. 8, 2018

(51) Int. Cl. B65B 51/30; B29C 65/20; B29C 65/00

(52) U.S. Cl. CPC B65B 51/303; B29C 65/20; B29C 66/43121; B29L 2031/7128; B29C 66/83221; B29C 66/90; B29C 66/814

(57) ABSTRACT

An adjustable sealing apparatus and corresponding method of use is disclosed. The sealing apparatus has a variable range of motion programmed to accommodate multiple types of sealing motion, including the reciprocal motion and rotary motion. The proposed design uses two sealing jaw units with each sealing jaw unit located on opposing sides of a continuous layered film. Each sealing jaw unit has a sealing jaw coupled to a distal end of extendable linkages. The sealing jaws are extendable to allow the sealing surfaces to engage one another at a plurality of sealing locations along a plurality of sealing paths. Moreover a control unit is communicatively coupled to each of the sealing jaw units and controls movement of the sealing jaw units to engage one another at one or more of the plurality of sealing locations which enables sealing of the film to produce bags.

### BACKGROUND

### Technical Field

The present disclosure relates to an adjustable sealing apparatus and method for sealing film. More particularly, the disclosure describes an improved sealing apparatus with opposing sealing jaws, each of which is capable of moving along one of a plurality of sealing motions to create bags of various form factors.

### Background

Vertical fill form and seal machines (“VFFS machines”) are commonly used to bag particulate products, including, but not limited to, snack foods that are particulate in nature. Particulate snack foods include, but are not limited to, potato chips, corn chips, and extruded snack pieces of various shapes and sizes. These usually enter near the top end of the VFFS machine in measured charges and are each then sealed into a package that is formed on the machine, from packaging film, to contain the snack food charge. The packaging film is most commonly of a heat sealable polymeric composition. In the heat sealing process, there are several variables, but significant among these are the applied pressure of the jaws, the dwell time (i.e. the time that the pressure is applied) and the seal temperature. The seal temperature is generally determined by the packaging material. But, the applied pressure and the dwell time are parameters that an operator can manipulate.

In some VFFS machines the package film advances downward around a forming tube where the free ends of the film are sealed together along the side of the forming tube and sealed transversely by a sealing device as it travels below the forming tube. The partially formed bag having a sealed side and bottom end is then filled with the particulate charge and the top of the bag being formed is sealed with another transverse seal.

In some VFFS machines, the motion of the packaging film is halted intermittently as the film is being transversely sealed to form the bag. The step of heat sealing requires a finite amount of time to complete. Consequently, VFFS machines of this type are of intermittent operation.

In other VFFS machines, which are of continuous operation, there is a jaw assembly that has a pair of opposed jaws that are each mounted to a common rail so that they slide on the rail toward each other to close and thereby seal the film gripped between the jaws, and slide away from each other to an open position. In addition, the jaw assembly has a vertical rail along which the common rail (with its mounted opposed jaws) can slide up and down. Thus, during operation, the sealing elements on the faces of the opposed jaws move in a “box mode:” inward to pinch the packaging film between the jaws, and the downward, at the same speed as the traveling film, while still applying pinching pressure to form the transverse seal. The jaws separate outward away from the film once the seal is formed; and then move upward in position for again pinching inward to form the next seal. A point at the leading edge of each sealing element traces a locus (“path”) that is a rectangle and that can be described as a “box.” These box-mode jaws can form transverse seals while the film moves continuously. Box-mode jaw assemblies are relatively heavy but they can apply relatively high sealing pressure, and have relatively high seal dwell time. They can be used with large bags, such as large pillow bags. And, they are useful in making formatted bags, including but not limited to single sided gusseted bags, or double sided gusseted bags, or bags with a base shaped for standing upright for display. But, they are relatively slow in terms of bags made per minute.

In a variation of the box-mode jaws described above, the jaws may trace a D-shaped locus. These jaws are relatively faster than the box-mode, and can apply moderate seal dwell times, and moderate seal pressure. They are not as capable as the box-mode in terms of the variety of formatted bags that they are suited to making.

In yet other VFFS machines, there are fixedly positioned opposed rotary arms, one on each side of the packaging film. Each rotary arm carries a heat sealing element to form the transverse seal. These heat sealing elements are convex inboard, presenting an outward curved surface facing towards the packaging film. (By “inboard,” we mean the side that would face the packaging film during operation of the sealing jaws.) Thus, as the rotary arms rotate, the heat sealing elements on each side rotate into positions where they register and urge against opposite sides of the packaging film as the arms rotate to create a transverse heat seal. The opposed sealing elements contact the film, during sealing, along the convex opposed surfaces to apply pressure and heat. Further, as the rotary arms rotate a point at the leading edge of each sealing element traces a locus that can be described as a circle. The VFFS machine is of continuous operation in that the packaging film advances without interruption as the transverse seal of the bag is formed. These jaws are able to operate continuously at high speed in terms of bags/minute. They are able to apply very high seal pressure, but for very short dwell times. Because of the structure of the rotary jaws, they are not well-suited to sealing large bags. And they are not suited to making formatted bags because they spatially interfere with the placement of formers. They are, by and large, limited to pillow bags.

In a variation of the rotary type of VFFS machine, the heat sealing elements are mounted to the rotary arms so that they are able to reticulate to a limited extent so that the faces of the sealing elements may be squarely aligned to each other during the formation of the seal.

### SUMMARY OF THE INVENTION

In accordance with a first embodiment, a film sealing apparatus is provided having opposing sealing jaws, each of which is capable of moving along one of a plurality of sealing motions to create bags of various form factors. Currently multiple different machines are required to seal different types of bags, or a single machine may be used, however, is unable to run at optimal rates for every type of bag. For example, a reciprocating machine is able to seal a format bag, but the system will not run a standard pillow bag at the same rate. The proposed jaw system of the present disclosure is capable of the reciprocating motion but is also capable of a rotary motion at high rates due to the light weight of the jaws.

The sealing apparatus has a first sealing jaw unit opposing a second sealing jaw unit, both of which are communicatively coupled with a control unit to control movement of the first sealing jaw unit and the second sealing jaw unit. More specifically, the sealing apparatus has a first sealing jaw mounted on a first side of a film path. The first sealing jaw unit includes a first sealing jaw coupled to a distal end of a first set of extendable linkages, and also includes a first sealing surface. The sealing apparatus also has a second sealing jaw unit mounted on an opposite side of the film path. Additionally, the second sealing jaw includes a second sealing jaw coupled to a distal end of a second set of extendable linkages, and also includes a second sealing surface. The first sealing jaw and the second sealing jaw are extendable to allow the first sealing surface to engage the second sealing surface using one of a plurality of sealing paths. The sealing apparatus also includes a control unit communicatively coupled to the first sealing jaw unit and the second sealing jaw unit, which controls movement of the first sealing jaw and the second sealing jaw to engage the first and the second sealing surfaces using one of a plurality of sealing paths.

In accordance with a second embodiment, a film sealing method is provided that includes the steps of: providing a first sealing jaw unit on a first side of a film path with a first sealing jaw coupled to a distal end of its first set of extendable linkages; providing a second sealing jaw unit on a second side of the film path with a second sealing jaw coupled to a distal end of its second set of extendable linkages, in which the first sealing jaw and the second sealing jaw are extendable to allow the first sealing surface to engage the second sealing surface in a number of potential sealing locations; determining a first sealing path for the first sealing jaw; determining a second sealing path for the second sealing jaw so that movement of the first sealing jaw along the first sealing path and movement of the second sealing jaw along the second sealing path causes the first sealing jaw and the second sealing jaw to meet at any one or more of the plurality of sealing locations located along the film path; extending a film along the film path; and sealing the film between the two sealing jaws at any one or more of a plurality of sealing locations.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 depicts a bagmaker configured with a pair of sealing jaws in accordance with an illustrative embodiment.

FIG. 2A depicts a pair of opposing sealing jaw units in accordance with an illustrative embodiment.

FIG. 2B depicts a perspective view of a sealing jaw unit, for example, the first sealing jaw unit according to one embodiment.

FIGS. 3A-B depicts a set of linear actuators used to actuate secondary linkages in order to rotate the sealing jaw surface in accordance with an illustrative embodiment.

FIGS. 3C-D depicts a set of rotary actuators used to actuate secondary linkages in order to rotate the sealing jaw surface in accordance with an illustrative embodiment.

FIGS. 4A-D depicts a simplified schematic of a number of potential sealing jaw path and pattern examples.

FIG. 5 depicts a schematic view of the invention in the context of a film sealing environment in accordance with an illustrative embodiment.

FIG. 6 is a flowchart of a process for sealing a bag in accordance with an illustrative embodiment.

### DETAILED DESCRIPTION

Novel aspects of the embodiments disclosed herein recognize the need for an improved film sealing apparatus and corresponding method for sealing film bags. The sealing apparatus includes opposing sealing jaw units that can accommodate variable sealing motions that can be adjusted to accommodate different bag types without the expense of limiting sealing rates and without the need to use separate sealing equipment for different bag types.

To facilitate the discussion and description of the various embodiments of the sealing apparatus, certain descriptive conventions may be used to describe the relative position or location of the features that form the apparatus as well as relative direction. For example, the terms “upstream” and “downstream” will be used to describe the locations relative to a film path. For example, embodiments of the film-sealing system disclosed herein can include a film path that extends from a roll, through a set of tensioners, and then at least partially around the outer surface of a former. Accordingly, the set of tensioners may be described as downstream from the roll but upstream from the surface of the former. Moreover, the terms “retracted position” and “extended position” will be used to describe the static arrangement of the extendable linkages when the sealing jaw surfaces are engaged and disengaged with one another. For example, a “retracted position” describes a position of the extendable linkages where the extendable linkages are drawn in toward its resting position at close proximity to its respective housing and the sealing jaw surfaces are not in contact with one another. An “extended position” describes a position of the extendable linkages where the extendable linkages are expanded out away from its respective housing and the sealing jaw surfaces are in contact with one another.

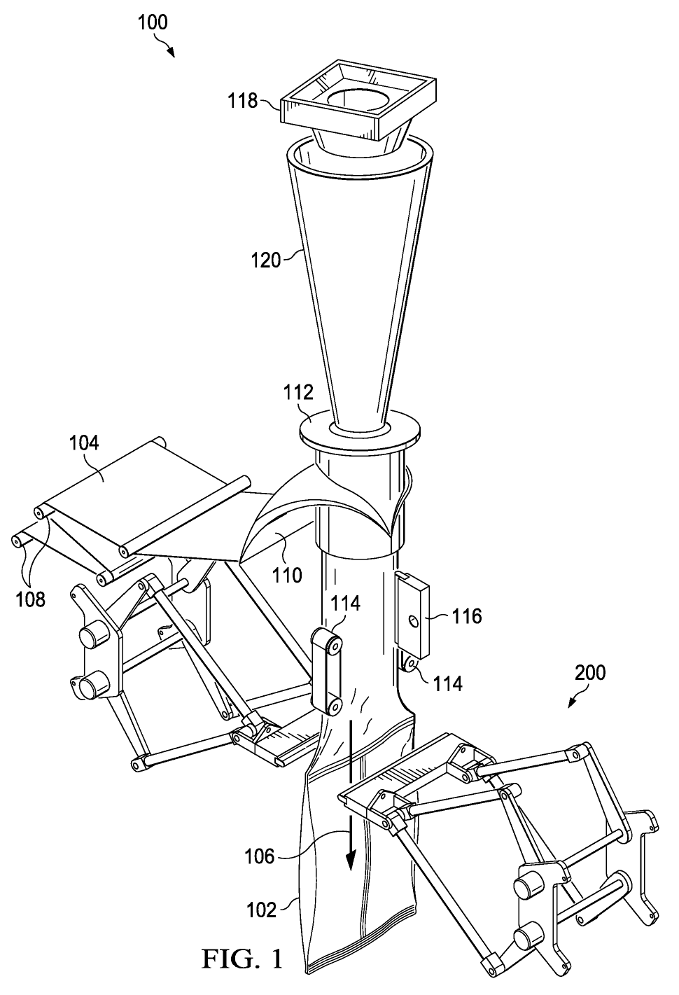

FIG. 1 depicts a bagmaker configured with a sealing apparatus in accordance with an illustrative embodiment. Bagmaker 100 is a vertical form, fill, and seal machine that forms bags 102 from film 104 stored on a roll (not shown) and drawn along a film path 106 that extends through a set of tensioners 108, and over a forming collar 110 that allows the film 104 to wrap around the outer surface of a former 110. The film path 106 is a predetermined set of positions along which film 104 travels: e.g., a path taken by film 104 through the bagmaker 100 as the film 104 is manipulated from a generally planar form factor to a filled bag 102. The film 104 is drawn along the length of the former 112 by a set of pull belts 114 while vertical sealer 116 seals the longitudinal edges of the film 104 together to form a tube of film. Transverse seals are formed in the tube of film by the novel sealing apparatus 200 located downstream from the pull belts 114 and on opposite sides of the film path 106.

In operation, partially formed bags are filled with product that are first weighed in weigher 118, and passed through funnel 120 and then former 112 before being deposited in a partially formed bag. The partially formed bag, now filled with product, is sealed on the upstream end by sealing apparatus 200 and detached from the tube to form the bag 102 filled with food product. In one embodiment, the sealing jaws of the sealing apparatus 200 have an integrated cutting surface that separates a downstream bag 102 from the upstream tube of film 104 when the transverse seal is formed, or shortly thereafter.

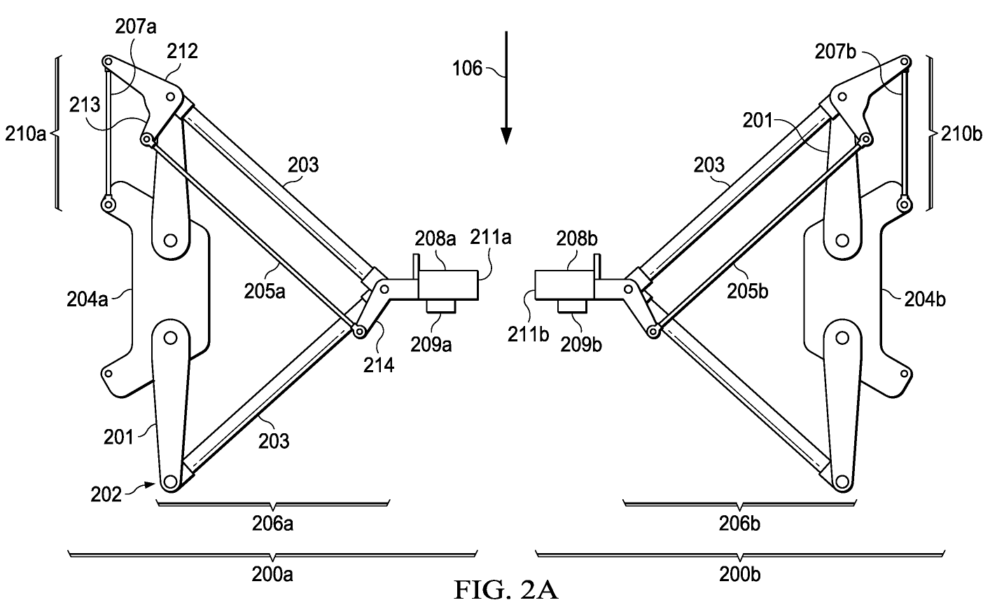

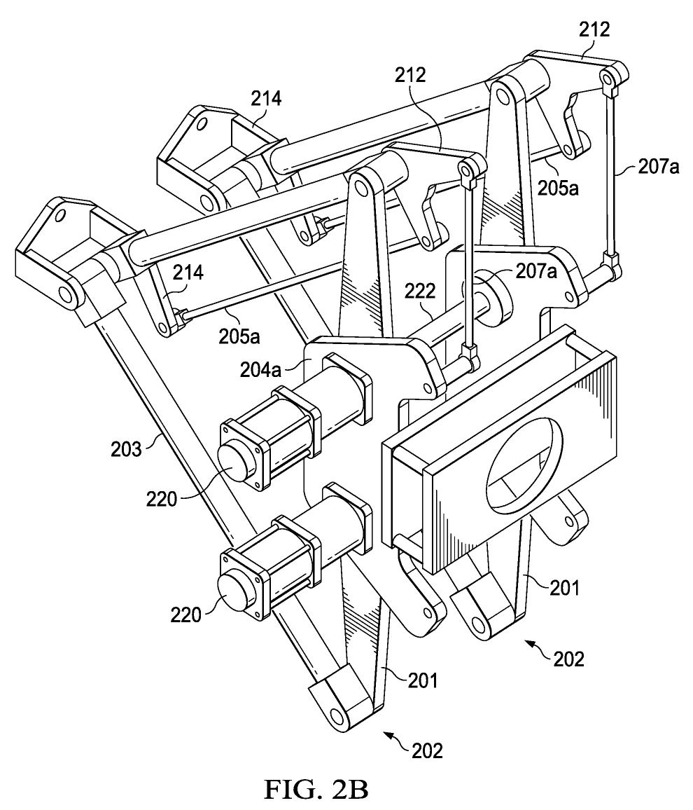

FIG. 2A depicts a sealing apparatus 200 in accordance with an illustrative embodiment. The sealing apparatus 200 can be generally described as a pair of opposing sealing jaw units mounted on opposing sides of a film path for sealing and optionally cutting a tube of film to form a bag. More specifically, the sealing apparatus 200 includes a first sealing jaw unit 200a mounted on a first side of film path 106, and a second sealing jaw unit 200b mounted on a second side of film path 106 and oriented to oppose the first sealing jaw unit 200a.

As shown in FIG. 2A, the first sealing jaw unit 200a has a first sealing jaw 208a coupled to a first housing 204a by a set of extendable linkages 206a. As used herein, the term “set of” means one or more. Thus, a set of extendable linkages can mean one extendable linkage, or two or more extendable linkages. As can be seen, the set of extendable linkages 206a in FIG. 2A includes more than one linkage, each of which is pivotally connected at its proximal end to the first housing 204a. Likewise, each of the set of extendable linkages 206a is also pivotally coupled to a first sealing jaw 208a at its distal end. Sealing apparatus 200 also includes a second sealing jaw unit 200b that includes a second sealing jaw 208b coupled to a second housing 204b by a set of extendable linkages 206b. Each of the set of extendable linkages 206b are pivotally connected to the second housing 204b and the second sealing jaw 208b. In the exemplary embodiment of FIG. 2A, the first and second sealing jaw units 200 are identical and symmetrical across the film path 106 located between the first and second sealing jaw units 200. The film path 106 in FIG. 2A is depicted to be linear and equidistant from the first and second sealing jaw units 200, however, the film path 106 may also flow along a non-linear path that may at some points be closer to one sealing jaw unit and at other points along the path be closer to the other sealing jaw unit.

Extension and retraction of the set of extendable linkages 206 causes the sealing surfaces 211 of the sealing jaws 208 to engage one another at one or more sealing locations that coincides with the film path 106. Motion is imparted to the set of extendable linkages 206 by actuators mounted within the housings 204, as can be seen in more detail in FIG. 2B. In some embodiments, the actuators may be servo actuators. In another exemplary embodiment, the actuators are rotary actuators. The increased variability in the range of motion of the sealing jaws 208 is attributable, in part, to the rotatable joint 202 that divides each of the extendable linkages 206 into a primary proximal link 201 and a primary distal link 203. In operation, the first and second sealing jaw units 200 are maintained at rest in a retracted position. Sealing is initiated by one or more actuators that imparts motion to the set of linkages 206, which rotates or pivots at one or more of the pivotal connections or rotatable joints 202. For example, in some embodiments, the actuators may be rotary actuators. In another exemplary embodiment, the actuators are servo actuators. The motion is transferred to the sealing jaws 208, causing each of the sealing jaws 208 to proceed along a predetermined sealing path until they meet at one or more of a plurality of sealing locations when the first and the second sealing jaw units 200 have achieved an extended position. Sealing occurs at the one or more of the plurality of sealing locations when the two sealing jaws 208 are in contact.

Because sealing occurs between the sealing surfaces 211 of the sealing jaws 208, the proper orientation of the sealing jaws 208 should be maintained at least during the sealing process. In this illustrative embodiment, proper orientation of the sealing jaws 208 are maintained by a plurality of secondary linkages 210. Each of the secondary linkages 210 includes a secondary proximal link 207 attached to a joint lever 213 that is in turn attached to a secondary distal link 205. More specifically, the secondary proximal link 207 is pivotally attached to the housing 204 on one end and connected to a joint lever 213 on the other end. The fulcrum of the joint lever 213 is located at the joint 212. The secondary proximal link 207 is maintained substantially parallel to the primary proximal link 201. Moreover a secondary distal link 205 is pivotally connected to the joint lever 213 on one end and a distal lever 214 on the other end. The primary distal link 203 is pivotally connected to the distal lever 214 at the fulcrum of the distal lever and the sealing jaw 208 is fixed on the opposite side of the distal lever 214 such that any movement in the primary distal link 203 causes the secondary distal link 205 to be maintained substantially parallel to the primary distal link 203 and the sealing jaw 208 orientation to be maintained. Alternatively, the orientation of the sealing jaw surfaces 211 may be modified while the sealing jaw unit 200 is in use by actuating the secondary linkages 210 using a rotary or linear actuator. In one aspect of the illustrative embodiment, the secondary linkages 210 are actuated independently from the primary linkages 206.

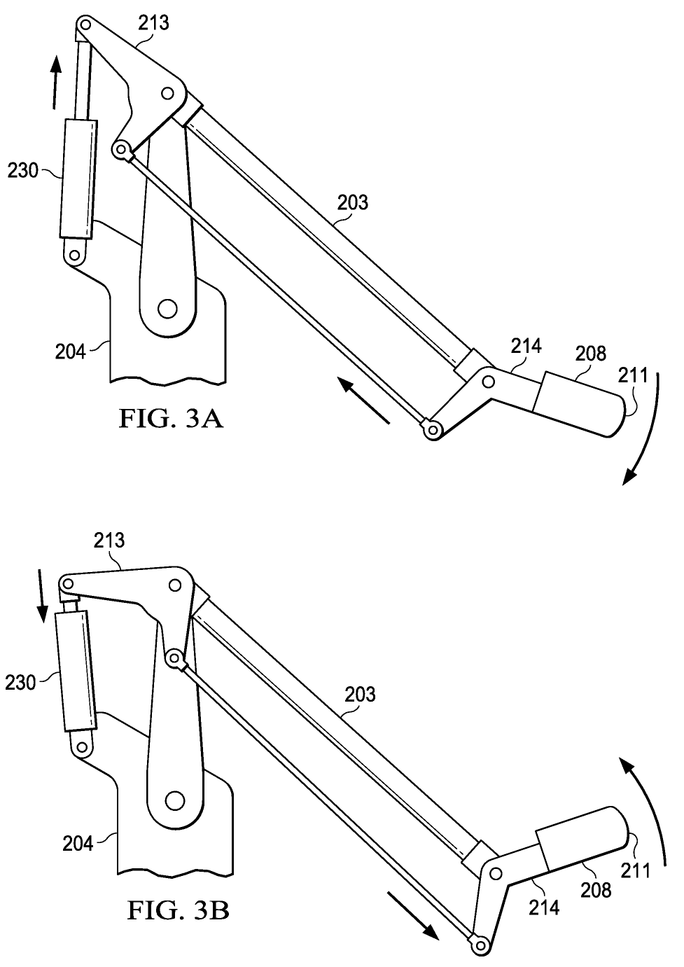

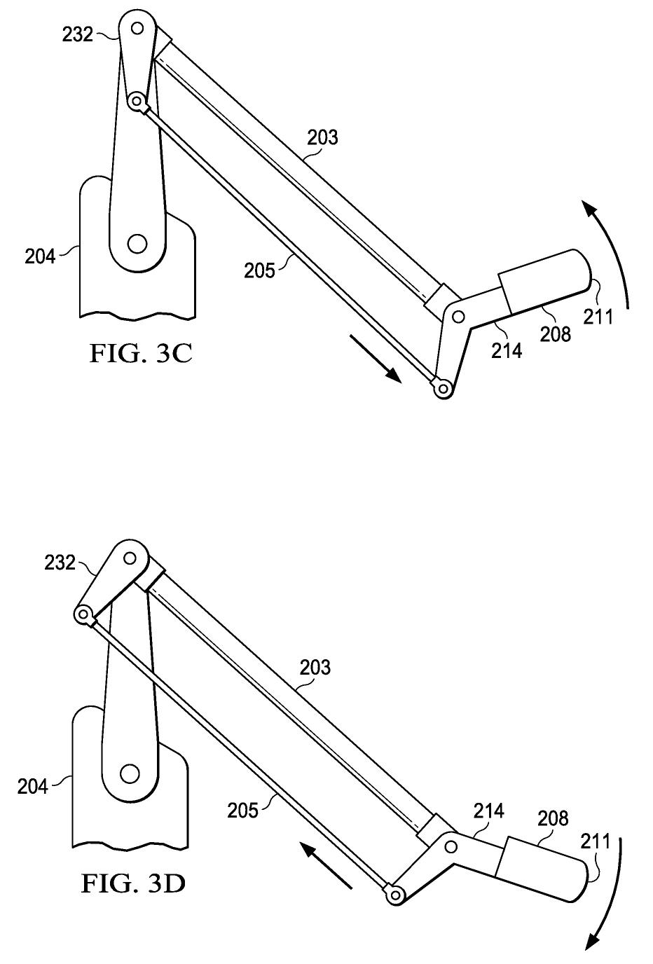

FIGS. 3A-B depicts a set of linear actuators used to actuate secondary linkages in order to rotate the sealing jaw 208 in accordance with an illustrative embodiment. For example, linear actuator 230 is pivotably coupled to the housing 204 and communicably coupled to control unit 502. Accordingly, the linear actuator 230 may extend or retract to actuate the lever 213 which modifies the position of the secondary link connected to the distal lever 214. A fully extended position of the linear actuator 230, is shown in FIG. 3A which corresponds to a sealing jaw that is rotated downward in a clockwise motion. A fully retracted position of the linear actuator 230, is shown in FIG. 3B which corresponds to a sealing jaw 208 that is rotated upward in a counterclockwise motion. The linear actuator may be pneumatic, hydraulic, electrical or any available linear actuator known in the industry. In one embodiment, a set of linear actuators 230 may be used to actuate each set of secondary linkages 210. Alternatively, a single linear actuator 230 may be used to actuate both sets of secondary linkages on each unit 200a or 200b using appropriate connections.

FIGS. 3C-D depicts a set of rotary actuators used to actuate secondary linkages in order to rotate the sealing jaw 208 in accordance with an illustrative embodiment. For example, rotary actuator 232 is coupled to secondary link 205 and communicably coupled to control unit 502. Accordingly, the rotary actuator 232 rotates in both the clockwise and counterclockwise direction which actuates the secondary link 205 which is connected to the distal lever 214. A rotation in the counterclockwise direction is shown in FIG. 3C which corresponds to a sealing jaw oriented in an upward, counterclockwise position. A rotation in the clockwise direction is shown in FIG. 3D which corresponds to a sealing jaw oriented in a downward, clockwise position. In one embodiment, a set of rotary actuators may be used to actuate each set of secondary linkages. Alternatively, a single rotary actuator may be used to actuate both sets of secondary linkages on each unit 200a or 200b using appropriate connections. In another illustrative embodiment, the rotary actuator may be used at location 214. For example, a rotary actuator at location 214 would eliminate the need for the sets of secondary linkages because the orientation of the seal jaw may be controlled directly on the lever 214 on which the sealing jaw is coupled to. In one embodiment, the sealing jaw surfaces 211 are rounded to accommodate a rotational motion upon contact with one another.

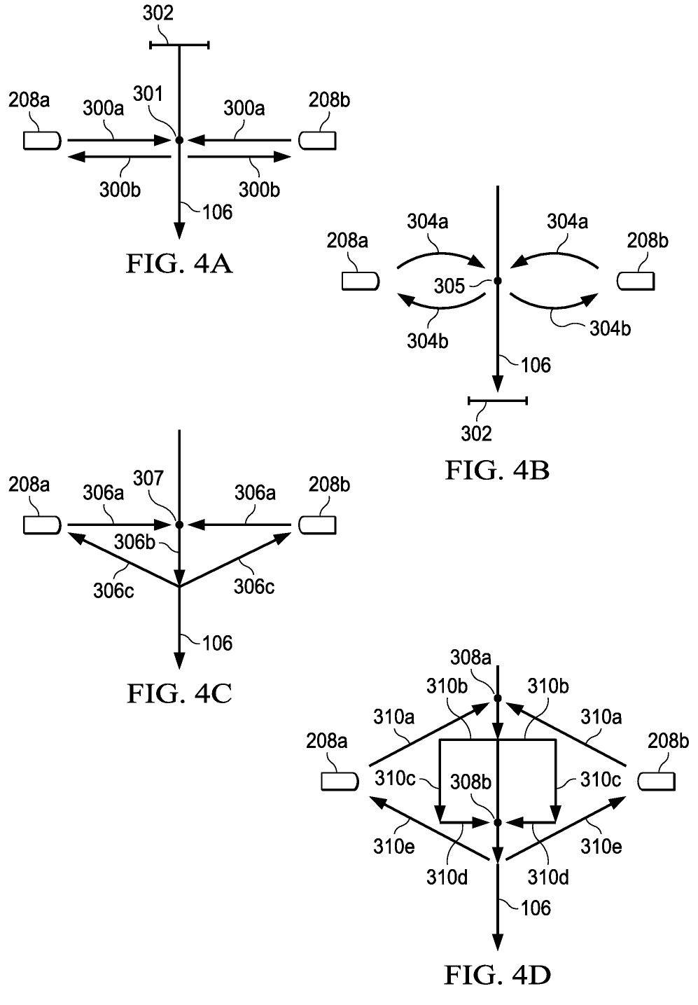

In addition to modifying sealing jaw orientation during the sealing process, sealing paths and sealing locations may also be modified in-process as illustrated in FIGS. 4A to 4D. For example, FIG. 4A depicts a reciprocating motion in which the first and second sealing jaws 208 repeatedly meet in the same sealing location 301 using sealing jaw path 300a and returning substantially along the same path 300b. In an exemplary embodiment, the sealing jaw path 300a starts with the first and second sealing jaws 208 in retracted positions, then moves into extended positions and returns back to retracted positions. In another exemplary embodiment, rather than returning to retracted positions, an open sealing jaw clearance 302 between the first and second seal jaws is maintained to allow the film to continue down film path 106 before the next sealing motion occurs. The clearance 302 may optionally be adjusted based on any number of factors including film 104 thickness and film path orientation.

FIG. 4B depicts a rotary sealing motion in which the first and second sealing jaws 208 rotate in opposing directions and meet at a location 305 within the volume 500 along path 304a. The film path 106 coincides with the tangential direction of both the first and second sealing jaw paths 304a along the meeting location 305 of the first and second sealing jaws 208. The sealing jaw return path 304b completes the rotational motion back to the starting point of the sealing jaws 208. In an exemplary embodiment, the starting point is the retracted position of the first and second sealing jaws. In another exemplary embodiment the rotary motion maintains a clearance 302 instead of returning to a retracted position.

FIG. 4C depicts a sealing motion in which the sealing jaws 208 extend in a linear path 306a that meets on a location 307 along the film 104 and moves along the film path 106 shown in path 306b at a rate consistent with the rate of the film 104 to prevent disrupting the film 104 along the film path 106 or in order to facilitate draw-down of the film 104 along the film path 106. The sealing jaws 208 then return to the original retracted positions using sealing jaw path 306c. In another exemplary embodiment, the sealing jaws 208 do not return to the original retracted position and instead maintains a clearance 302 between sealing.

FIG. 4D depicts a sealing pattern in which the sealing jaws meet and retract at a location at one point 308a along film path 106 following sealing jaw path 310a during extension and sealing jaw path 310b during a retraction before following sealing jaw path 310c to a location downstream of location 308a along the film path 106 at a rate greater than the rate of the continuous film 104. The first and second sealing jaws 208 then meet again at the downstream meeting location 308b along the film path 106 using sealing jaw path 310d before returning to the retracted position using sealing jaw path 310e.

Although FIGS. 4A-D depict meeting locations that are equidistant from the first and second sealing jaws, the meeting locations do not necessarily have to be equidistant from the first and second sealing jaws. For example, the meeting locations may be closer to the first sealing jaw or it may be closer to the second sealing jaw depending on the position of the film. Moreover, the first sealing jaw path does not necessarily have to be the same as the second sealing jaw path with respect to the film. Each sealing jaw may move in different patterns and speeds from one another depending on the position of the film or the type of bag. In one embodiment, the rate at which the sealing jaws 208 engage and disengage one another may be adjusted based on the rate of the film 104 moving along the film path 106. In another embodiment, the period of contact time between the first and second seal jaw surfaces 211 may be adjusted based on the type of film 104 used. For example, the thickness of the film 104, the number of layers of the film 104, and the type of material or resin of the film 104.

As depicted in FIG. 2A, the first and second sealing jaws 208a and 208b, are each configured with sealing elements 209a and 209b, respectively. For example, sealing elements may be heating elements or ultrasonic elements which may be configured to sealing jaws using any conventional method or design known in the industry. The sealing elements 209 may heat either sealing jaws 208 or both sealing jaws to a range of temperatures necessary to heat seal the film 104 upon contact with both of the sealing jaws 208. The temperature of the sealing jaw surfaces 211 may be adjusted in synchronization with one another, or the temperature of the sealing jaws surfaces 211 may be adjusted independently from one another. In an exemplary embodiment, the temperature of the sealing jaw surfaces 211 may be adjusted based on the type bag 102 or the type of film 104 used for the bag 102.

Moreover contact pressure and contact time may also be adjusted based on similar factors such as the type bag 102 or the type of film 104 used for the bag 102. For example, the thickness of the film 104, the number of layers of the film 104, and the type of material or resin of the film 104. In an exemplary embodiment, the contact pressure or “jaw force” may be about 500 to 2,000 lbf, the contact time required to maintain contact between the jaws may be 70 to 500 milliseconds, the width of the first and second sealing jaws may be about 0.25″ to about 1.5″, and the weight of the first and second sealing jaws may be about 6 to 7 lbs each.

FIG. 2B shows an alternate angled perspective of a sealing jaw unit 200, for example the first sealing jaw unit 200a with four extendable linkages 206 along with actuators 220 that drive the extendable linkages 206. In one embodiment, each rotary actuator 220 drives a shaft 222 located in the first housing 204a that is connected to a pair of extendable linkages 206. Similarly, one or more actuators 220 are located in the second housing 204b. For example, a system with eight total extendable linkages 206 may require a total of four actuators 220. In the illustrative embodiment shown in FIG. 2B, the actuator 220 drives the pair of extendable linkages 206 by rotating the shaft 222 in either direction. The extendable linkages 206 move the sealing jaws 208 over a number of positions while maintaining the sealing jaws 208 in the same orientation such that the sealing jaw surfaces 211 are substantially parallel to one another. In one embodiment, the surface orientation may be achieved using a set of secondary links such as 205a, 205b, 207a, and 207b shown in FIG. 2A and can be configured to all of the extendable linkages 206 or can be configured to a select number of extendable linkages. The illustrative embodiment shown in FIG. 2A, for example, shows the secondary link structure installed on four out of eight extendible linkages. Moreover, maintaining an orientation at a distal end of a similar extendable linkage structure may also be achieved using any method known in the industry. Consequently, the first and second sealing jaws are oriented such that the first and second sealing jaw surfaces 211a and 211b, respectively, are parallel to one another on opposing sides of the film path 106. Alternatively, the orientation of the sealing jaw surfaces may be modified while the sealing jaw unit is in use by actuating the secondary linkages using a rotary or linear actuator as shown in FIG. 3A to D.

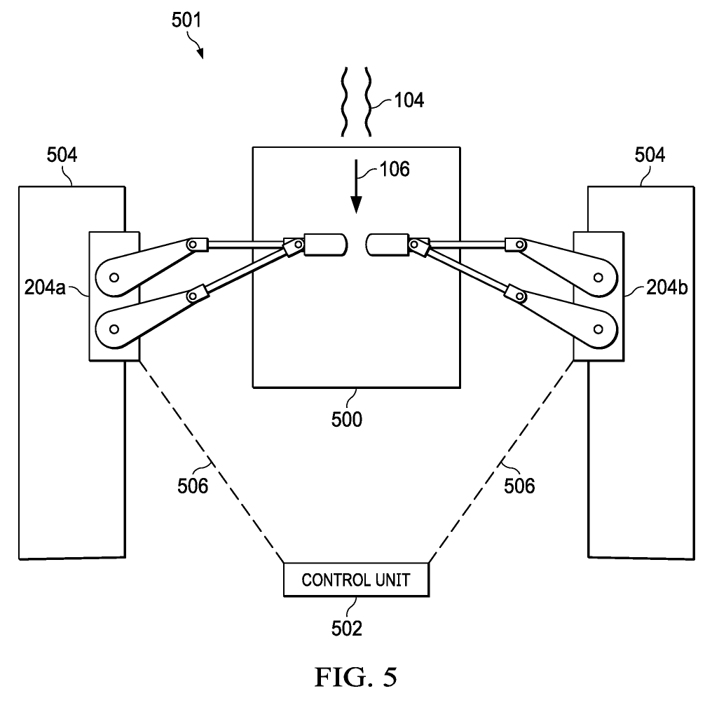

FIG. 5 depicts a schematic view of the invention in the context of a film sealing environment 501 in accordance with an illustrative embodiment. The film 104 is depicted continuously flowing along a film path 106 between the first and second sealing jaw unit 200. The sealing jaw area defining the locations in which the sealing jaws may meet is defined in an area 500 between the first and second sealing jaw units 200. In one embodiment, the position within the plurality of locations that the first and second sealing jaws 208 may engage in area 500 is adjusted depending on the position of the film path 106.

A control unit 502 is able to control the motion of the first and second sealing jaw units 200 using a communication link 506 such as a cable or a wireless signal or any communication method known in the art.

More particularly, the control unit 502 is coupled via the communication link (or signal) 506 to the actuators 220 located in each of the first 204a and second 204b housing. The signal 506 causes the actuators 220 to rotate in either direction in order to drive the shaft 222 which also rotates the extendable linkages 206. The first set of linkages 206a may be driven independently from the second set of extendable linkages 206b.

Each of the first 204a and second 204b housings are mounted on vertical frame supports 504. It can be appreciated that the first 204a and second 204b housings may be mounted on vertical frame supports, platforms, rails, vertical walls, and/or on the floor.

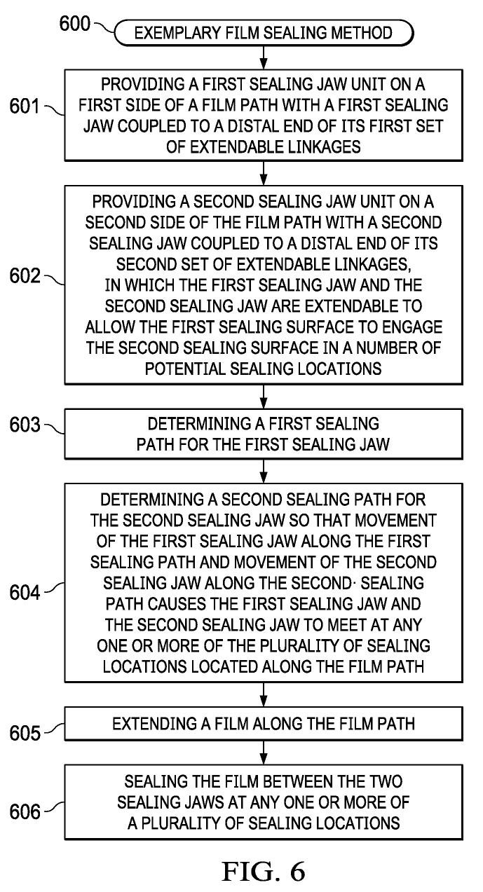

FIG. 6 is a flowchart of a method for sealing a film in accordance with an illustrative embodiment. The method may be performed by a sealing apparatus, such as sealing apparatus 100 in FIG. 1. The method includes the steps of:

providing a first sealing jaw unit on a first side of a film path with a first sealing jaw coupled to a distal end of its first set of extendable linkages in step 601; For example, the extendable linkages 206 may have a primary proximal link 201 and a primary distal link 203 coupled to one another at a rotatable joint 202.

providing a second sealing jaw unit on a second side of the film path with a second sealing jaw coupled to a distal end of its second set of extendable linkages, in which the first sealing jaw and the second sealing jaw are extendable to allow the first sealing surface to engage the second sealing surface in a number of potential sealing locations in step 602; For example, the first sealing surface 211a may be heated with or separately from the second sealing surface 211b. Moreover the sealing surface may be configured with an ultrasonic element.

determining a first sealing path for the first sealing jaw in step 603; For example, the first sealing path may be modified to accommodate the bag type.

determining a second sealing path for the second sealing jaw so that movement of the first sealing jaw along the first sealing path and movement of the second sealing jaw along the second sealing path causes the first sealing jaw and the second sealing jaw to meet at any one or more of the plurality of sealing locations located along the film path in step 604; For example, the first sealing path may be similar in pattern compared to the second sealing path, or it may follow a distinct pattern from the second sealing path.

extending a film along the film path in step 605; and

For example, FIG. 4C shows the sealing path 306a, 306b, and 306c in which the sealing surfaces 211 meet at location 307 along the film path 106 and move along the film direction to draw the film down along the film path 106.

sealing the film between the two sealing jaws at any one or more of a plurality of sealing locations in step 606.

For example, the sealing jaws may seal repeatedly at the same seal location as shown in FIG. 4A, or sealing may occur at location 308a and then again at a downstream location 308b as shown in FIG. 4D.

### Additional Embodiments

The following descriptive embodiments are offered as further support of the disclosed invention:

In a first embodiment, novel aspects described in the present disclosure are directed to a sealing apparatus comprising: a first sealing jaw unit mounted on a first side of a film path, wherein the first sealing jaw unit comprises a first sealing jaw coupled to a distal end of a first set of extendable linkages, and wherein the first sealing jaw has a first sealing surface; a second sealing jaw unit mounted on an opposite side of the film path, wherein the second sealing jaw comprises a second sealing jaw coupled to a distal end of a second set of extendable linkages, wherein the second sealing jaw comprises a second sealing surface, and wherein the first sealing jaw and the second sealing jaw are extendable to allow the first sealing surface to engage the second sealing surface along one of a plurality of sealing paths; and a control unit communicatively coupled to the first sealing jaw unit and the second sealing jaw unit, wherein the control unit controls movement of the first sealing jaw and the second sealing jaw to engage the first and the second sealing surfaces along one of a plurality of sealing paths.

In another aspect of the first embodiment, the sealing apparatus comprising: a first sealing jaw unit mounted on a first side of a film path, wherein the first sealing jaw unit comprises a first sealing jaw coupled to a distal end of a first set of extendable linkages, and wherein the first sealing jaw has a first sealing surface; a second sealing jaw unit mounted on an opposite side of the film path, wherein the second sealing jaw comprises a second sealing jaw coupled to a distal end of a second set of extendable linkages, wherein the second sealing jaw comprises a second sealing surface, and wherein the first sealing jaw and the second sealing jaw are extendable to allow the first sealing surface to engage the second sealing surface along one of a plurality of sealing paths; a control unit communicatively coupled to the first sealing jaw unit and the second sealing jaw unit, wherein the control unit controls movement of the first sealing jaw and the second sealing jaw to engage the first and the second sealing surfaces along one of a plurality of sealing paths; and further comprises one or more limitations selected from the following:

wherein the first set of extendable linkages are rotatably connected to a first housing, wherein the second set of extendable linkages are rotatably connected to a second housing, and wherein each of the extendable linkages further comprises: a primary proximal link; a primary distal link coupled to the primary proximal link at a rotatable joint;

a first plurality of actuators mounted within the first housing and coupled with the first set of extendable linkages, and a second plurality of actuators mounted within the second housing and coupled with the second set of extendable linkages; and wherein the first plurality of actuators causes the first sealing jaw to travel along a first sealing path, and wherein the second plurality of actuators causes the second sealing jaw to travel along a second sealing path intersecting the first sealing path at one or more of the plurality of sealing locations;

a first set of secondary linkages coupled with the first set of extendable linkages, wherein the first set of secondary linkages maintains an orientation of the first sealing jaw; a second set of secondary linkages coupled with the second set of extendable linkages, wherein the second set of secondary linkages maintains an orientation of the second sealing jaw; wherein the first sealing surface is maintained parallel to the second sealing surface;

a first set of secondary linkages coupled with the first set of extendable linkages, wherein the first set of secondary linkages is configured to modify the orientation of the first sealing jaw; a second set of secondary linkages coupled with the second set of extendable linkages, wherein the second set of secondary linkages is configured to modify the orientation of the second sealing jaw;

a first set of one or more linear actuators pivotably coupled to a first housing and coupled with the first set of secondary linkages, and a second set of one or more of linear actuators pivotably coupled to a second housing and coupled with the second set of secondary linkages; and wherein the first set of linear actuators actuates the first set of secondary linkages and causes the first sealing jaw to rotate, and wherein the second set of linear actuators actuates the second set of secondary linkages and causes the second sealing jaw to rotate.

a first set of one or more rotary actuators coupled with the first set of secondary linkages, and a second set of one or more rotary actuators coupled with the second set of secondary linkages; and wherein the first set of rotary actuators actuates the first set of secondary linkages and causes the first sealing jaw to rotate, and wherein the second set of rotary actuators actuates the second set of secondary linkages and causes the second sealing jaw to rotate;

wherein the control unit controls each of the actuators independently;

wherein each actuator powers a pair of extendable linkages;

a first sealing element coupled with the first sealing surface; and a second sealing element coupled with the second sealing surface;

wherein each of the set of extendable linkages comprises two pairs of extendable linkages;

wherein the plurality of sealing locations is defined by an area between the first and second sealing jaw units with dimensions perpendicular and parallel to the film path;

wherein each of the plurality of actuators comprises two actuators;

wherein the first and second sealing elements are heating elements;

wherein the first and second sealing elements are ultrasonic elements;

wherein the first and second plurality of actuators are servo actuators; and

wherein the first and second plurality of actuators are rotary actuators.

In a second embodiment, novel aspects of the present disclosure are directed to a film sealing method comprising the steps of: providing a first sealing jaw unit on a first side of a film path, wherein the first sealing jaw unit comprises a first sealing jaw coupled to a distal end of a first set of extendable linkages, and wherein the first sealing jaw has a first sealing surface; providing a second sealing jaw unit on a second side of the film path, wherein the second sealing jaw comprises a second sealing jaw coupled to a distal end of a second set of extendable linkages, wherein the second sealing jaw comprises a second sealing surface, and wherein the first sealing jaw and the second sealing jaw are extendable to allow the first sealing surface to engage the second sealing surface at one of a plurality of sealing locations; determining a first sealing path for the first sealing jaw; determining a second sealing path for the second sealing jaw, wherein movement of the first sealing jaw along the first sealing path and movement of the second sealing jaw along the second sealing path causes the first sealing jaw and the second sealing jaw to meet at one of the plurality of sealing locations located along the film path; extending a film along the film path; and sealing the film between the first sealing jaw and the second sealing jaw at one of the plurality of sealing locations.

In another aspect of the second embodiment, novel aspects of the present disclosure are directed to a method wherein the first sealing path and the second sealing path are defined/determined based on a bag type, the method further comprising one or more limitations selected from the following:

wherein sealing the film between the first sealing jaw and the second sealing jaw further comprises: moving the first sealing jaw along the first sealing path; moving the second sealing jaw along the second sealing path;

wherein the first set of extendable linkages are rotatably connected to a first housing, wherein the second set of extendable linkages are rotatably connected to a second housing, and wherein each of the extendable linkages further comprises: a primary proximal link; a primary distal link coupled to the primary proximal link at a rotatable joint;

wherein moving the first sealing jaw along the first sealing path further comprises extending the first sealing jaw along a first extension path and retracting the first sealing jaw along a first return path; and wherein moving the second sealing jaw along the second sealing path further comprises extending the second sealing jaw along a second extension path and retracting the second sealing jaw along a second return path;

wherein the first return path and the second return path coincide with/extend along at least a portion of the film path;

creating a sealing pattern wherein the first and second sealing jaws meet and retract in an upstream position of the film path, and wherein the first and second sealing jaws meet and retract in a downstream position of the film path;

selecting a bag type; and modifying the first sealing path and the second sealing path to accommodate the bag type;

maintaining a first sealing surface of the first sealing jaw parallel to a second sealing surface of the second sealing jaw;

heating the first sealing surface, or the second sealing surface, or combinations thereof; and

activating an ultrasonic sealer on the first sealing surface, or the second sealing surface, or combinations thereof.

Although the present disclosure has provided many examples of systems, apparatuses, and methods, it should be understood that the components of the systems, apparatuses and method described herein are compatible and additional embodiments can be created by combining one or more elements from the various embodiments described herein. As an example, in some embodiments, a method described herein can further comprise one or more elements of a system described herein or a selected combination of elements from any combination of the systems or apparatuses described herein. Furthermore, in some embodiments, a method described herein can further comprise using a system described herein, using one or more elements of a system described herein, or using a selected combination of elements from any combination of the systems described herein.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments. For example, it should be understood that the method steps described herein are exemplary, and upon reading the present disclosure, a skilled person would understand that one or more method steps described herein can be combined, omitted, re-ordered, or substituted.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

Where language, for example, “for” or “to”, is used herein in conjunction with an effect, function, use or purpose, an additional embodiment can be provided by substituting “for” or “to” with “configured for/to” or “adapted for/to.”

Additionally, when a range for a particular variable is given for an embodiment, an additional embodiment can be created using a subrange or individual values that are contained within the range. Moreover, when a value, values, a range, or ranges for a particular variable are given for one or more embodiments, an additional embodiment can be created by forming a new range whose endpoints are selected from any expressly listed value, any value between expressly listed values, and any value contained in a listed range. For example, if the application were to disclose an embodiment in which a variable is 1 and a second embodiment in which the variable is 3-5, a third embodiment can be created in which the variable is 1.31-4.23. Similarly, a fourth embodiment can be created in which the variable is 1-5.

As used herein, examples of “substantially” include: “more so than not,” “mostly,” and “at least 30, 40, 50, 60, 70, 80, 90, 95, 96, 97, 98 or 99%” with respect to a referenced characteristic. With respect to vectors, directions, movements or angles, that are “substantially” in the same direction as or parallel to a reference vector, direction, movement, angle or plane, “substantially” can also mean “at least a component of the vector, direction, movement or angle specified is parallel to the reference vector, direction, movement, angle or plane,” although substantially can also mean within plus or minus 45, 40, 35, 30, 25, 20, 15, 10, 5, 4, 3, 2, or 1 degrees of the reference vector, direction, movement, angle or plane.

As used herein, examples of “about” and “approximately” include a specified value or characteristic to within plus or minus 30, 25, 20, 15, 10, 5, 4, 3, 2, or 1% of the specified value or characteristic.

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A sealing apparatus comprising:
a first sealing jaw unit mounted on a first side of a film path, wherein the first sealing jaw unit comprises a first sealing jaw coupled to a distal end of a first set of extendable linkages, and wherein the first sealing jaw has a first sealing surface;
a second sealing jaw unit mounted on an opposite side of the film path, wherein the second sealing jaw comprises a second sealing jaw coupled to a distal end of a second set of extendable linkages, wherein the second sealing jaw comprises a second sealing surface, and wherein the first sealing jaw and the second sealing jaw are extendable to allow the first sealing surface to engage the second sealing surface at each of a plurality of sealing locations using one of a plurality of sealing paths; and
a control unit communicatively coupled to the first sealing jaw unit and the second sealing jaw unit, wherein the control unit controls movement of the first sealing jaw and the second sealing jaw to engage the first and the second sealing surfaces at one or more of the plurality of sealing locations using one of a plurality of sealing paths.

2. The sealing apparatus of claim 1, wherein the first set of extendable linkages are rotatably connected to a first housing, wherein the second set of extendable linkages are rotatably connected to a second housing, and wherein each of the extendable linkages further comprises:
a primary proximal link;
a primary distal link coupled to the primary proximal link at a rotatable joint.

3. The sealing apparatus of claim 2, further comprising a first plurality of actuators mounted within the first housing and coupled with the first set of extendable linkages, and a second plurality of actuators mounted within the second housing and coupled with the second set of extendable linkages; and
wherein the first plurality of actuators causes the first sealing jaw to travel along a first sealing path, and wherein the second plurality of actuators causes the second sealing jaw to travel along a second sealing path intersecting the first sealing path at one or more of the plurality of sealing locations.

4. The sealing apparatus of claim 1, further comprising:
a first set of secondary linkages coupled with the first set of extendable linkages, wherein the first set of secondary linkages maintains an orientation of the first sealing jaw;
a second set of secondary linkages coupled with the second set of extendable linkages, wherein the second set of secondary linkages maintains an orientation of the second sealing jaw;
wherein the first sealing surface is maintained parallel to the second sealing surface.

5. The sealing apparatus of claim 1, further comprising:
a first set of secondary linkages coupled with the first set of extendable linkages, wherein the first set of secondary linkages is configured to modify the orientation of the first sealing jaw;
a second set of secondary linkages coupled with the second set of extendable linkages, wherein the second set of secondary linkages is configured to modify the orientation of the second sealing jaw.

6. The sealing apparatus of claim 5, further comprising a first set of linear actuators pivotably coupled to a first housing and coupled with the first set of secondary linkages, and a second set of linear actuators pivotably coupled to a second housing and coupled with the second set of secondary linkages; and
wherein the first set of linear actuators actuates the first set of secondary linkages and causes the first sealing jaw to rotate, and wherein the second set of linear actuators actuates the second set of secondary linkages and causes the second sealing jaw to rotate.

7. The sealing apparatus of claim 5, further comprising a first set of rotary actuators coupled with the first set of secondary linkages, and a second set of rotary actuators coupled with the second set of secondary linkages; and
wherein the first set of rotary actuators actuates the first set of secondary linkages and causes the first sealing jaw to rotate, and wherein the second set of rotary actuators actuates the second set of secondary linkages and causes the second sealing jaw to rotate.

8. The sealing apparatus of claim 3, wherein the control unit controls each of the actuators independently.

9. The sealing apparatus of claim 3, wherein each actuator powers a pair of extendable linkages.

10. The sealing apparatus of claim 1, further comprising:
a first sealing element coupled with the first sealing surface; and
a second sealing element coupled with the second sealing surface.

11. The sealing apparatus of claim 1, wherein each of the set of extendable linkages comprises two pairs of extendable linkages.

12. The sealing apparatus of claim 3, wherein the plurality of sealing locations is defined by an area between the first and second sealing jaw units with dimensions perpendicular and parallel to the film path.

13. The sealing apparatus of claim 3, wherein each of the plurality of actuators comprises two actuators.

14. The sealing apparatus of claim 10, wherein the first and second sealing elements are heating elements.

15. The sealing apparatus of claim 10, wherein the first and second sealing elements are ultrasonic elements.

16. A film sealing method comprising the steps of:
providing a first sealing jaw unit on a first side of a film path, wherein the first sealing jaw unit comprises a first sealing jaw coupled to a distal end of a first set of extendable linkages, and wherein the first sealing jaw has a first sealing surface;
providing a second sealing jaw unit on a second side of the film path, wherein the second sealing jaw comprises a second sealing jaw coupled to a distal end of a second set of extendable linkages, wherein the second sealing jaw comprises a second sealing surface, and wherein the first sealing jaw and the second sealing jaw are extendable to allow the first heated surface to engage the second heated surface at one of a plurality of sealing locations;
extending a film along a film path; and
sealing the film between the first sealing jaw and the second sealing jaw at any one or more of a plurality of sealing locations;
determining a first sealing path for the first sealing jaw;
determining a second sealing path for the second sealing jaw, wherein movement of the first sealing jaw along the first sealing path and movement of the second sealing jaw along the second sealing path causes the first sealing jaw and the second sealing jaw to meet at any one or more of the plurality of sealing locations located along the film path;
sealing the film between the first sealing jaw and the second sealing jaw at any one or more of the plurality of sealing locations.

17. The method of claim 16, wherein moving the first sealing jaw along the first sealing path further comprises extending the first sealing jaw along a first extension path and retracting the first sealing jaw along a first return path; and
wherein moving the second sealing jaw along the second sealing path further comprises extending the second sealing jaw along a second extension path and retracting the second sealing jaw along a second return path.

18. The method of claim 17, wherein the first return path and the second return path coincide with/extend along at least a portion of the film path.

19. The method of claim 17, further comprising:
creating a sealing pattern wherein the first and second sealing jaws meet and retract in an upstream position of the film path, and wherein the first and second sealing jaws meet and retract in a downstream position of the film path.

20. The method of claim 16, further comprising:
selecting a bag type; and
modifying the first sealing path and the second sealing path to accommodate the bag type.
